(19) United States
(12) Patent Application Publication
(10) Pub. No.: US 2005/0274715 A1
(43) Pub. Date: Dec. 15, 2005

(54) Carbon based heating device, system and method of use thereof

(76) Inventor: Roy Johnson, Earlton, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/856,497

(22) Filed: May 28, 2004

(51) Int. Cl. H05B 1/00

(52) U.S. Cl. 219/548

(57) ABSTRACT

A carbon based heating device, method and system of use thereof is presented. The heating device for an epidermal region of the body includes: a power assembly, a heating assembly, a power distribution network, and a power control unit. The method for heating an epidermal region of the body includes: providing a power assembly, providing a heating assembly, providing a power distribution network, providing a power control unit, and providing heat. The system for heating an epidermal region of the body includes: a power source, a power assembly, a heating assembly, a power distribution network, and a power control unit.

### BACKGROUND OF THE INVENTION

1. Field of the Invention

The present invention relates to a device, a method, and a system for localized heating of different regions of the human body, and in particular, epidermal regions.

2. Related Art

In the field of personal heating, efforts toward devices and systems able to effectively and efficiently heat different regions of the human body are continuously being made, especially for the epidermal region. However, current heating devices and systems for the epidermal region, during sports, leisure, and the like, often require permanent and/or destructive modifications to the article of wear. Further, the costs of the articles of wear, such as ski boots, hunting boots, and the like naturally prohibit users from installing such heating devices and systems for fear of such costly modifications. Another issue is the size of current devices. Current heating devices often are thick and bulky adversely affecting the fitting of most articles of wear.

Thus, there is a need for a device, system and method which overcomes at least one of the aforementioned, and other, deficiencies in the art of personal heating, especially of the epidermal region.

### SUMMARY OF THE INVENTION

In a first general aspect of the present invention is provided a heating device comprising: a power assembly, wherein the power assembly is for containing a power source; a heating assembly, wherein the heating assembly includes at least one carbon based heating component; a power distribution network for distributing power from the power assembly to heating assembly; and a power control unit, wherein the power control unit manages the power distributed along the power distribution network.

In a second general aspect of the present invention is provided a method for heating comprising: providing a power assembly, wherein the power assembly is for containing a power source; providing a heating assembly, wherein the heating assembly includes at least one carbon based heating component; providing a power distribution network for distributing power from the power assembly to the heating assembly; providing a power control unit, wherein the power control unit manages the power distributed along the power distribution network; and providing heat.

In a third general aspect of the present invention is provided a system for heating comprising: a power assembly, wherein the power assembly is for containing a power source; a heating assembly, wherein the heating assembly includes at least one carbon based heating component; a power distribution network for distributing power from the power assembly to the heating assembly; and a power control unit, wherein the power control unit manages the power distributed along the power distribution network.

The foregoing and other features and advantages of the invention will be apparent from the following more particular description of preferred embodiments of the invention.

### BRIEF DESCRIPTION OF THE DRAWINGS

In order that those skilled in the art will be better able to practice the invention, reference will be made to the drawings, wherein:

FIG. 1 depicts a perspective view of a heating device in accordance with the present invention;

FIG. 2 depicts a perspective view of a power assembly in accordance with the present invention;

FIG. 3 depicts an exploded view of a power control unit in accordance with the present invention;

FIG. 4 depicts a top cross-sectional view of the power control unit in accordance with the present invention;

FIG. 5 depicts a perspective view of a heating assembly in accordance with present invention;

FIG. 6 depicts a perspective view of a power distribution network in accordance with the present invention;

FIG. 7 depicts a schematic of a power flow of the heating device in accordance with the present invention;

FIG. 8 depicts a heating system in accordance with the present invention;

FIG. 9 depicts a view of the heating system on a user in accordance with the present invention;

FIG. 10 depicts a cross section of a boot having a heating system in accordance with the present invention;

FIG. 11 depicts a view of a glove having the heating system in accordance with the present invention; and

FIG. 12 depicts a view of a human body having the heating system in accordance with the present invention.

### DETAILED DESCRIPTION OF PREFERRED EMBODIMENTS

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of the embodiment.

The present invention offers a device, a method, and a system for localized heating of different regions of the human body, and in particular, the epidermal region. Although for purposes of illustration only, an embodiment that can be used for heating inter alia the epidermis is disclosed herein. The device, method, and system can be used for heating epidermal regions of the human body such as a shoulder, a lower back, a hand and the like.

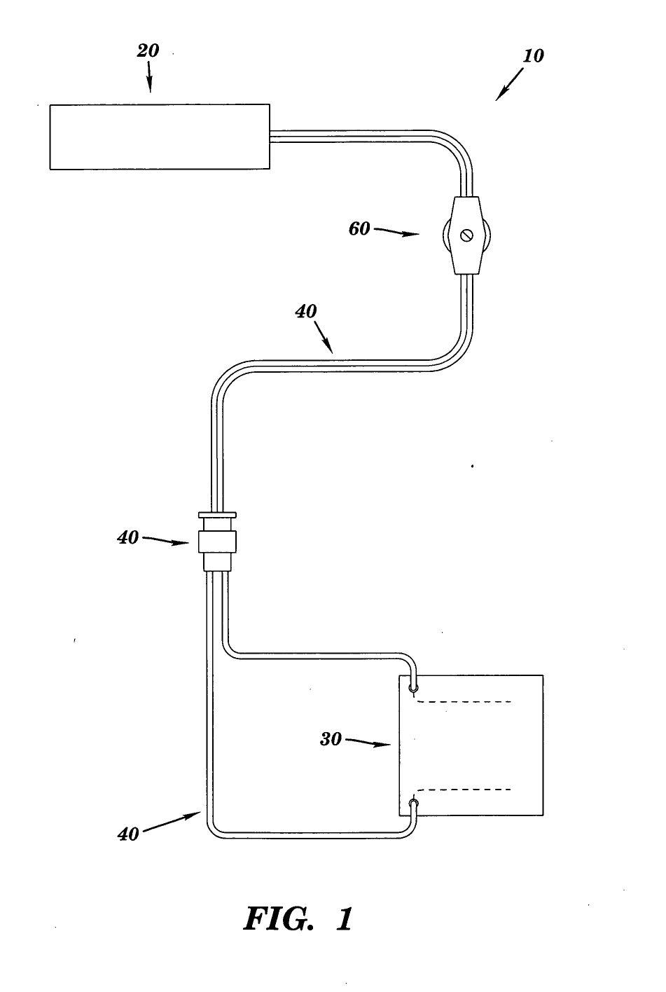

FIG. 1 depicts a heating device 10 for heating regions of a human body, in accordance with the present invention. An embodiment of the present invention is the heating device 10 comprising: a power assembly 20, a power control unit (PCU) 60, a heating assembly 30, and a power distribution network (PDN) 40.

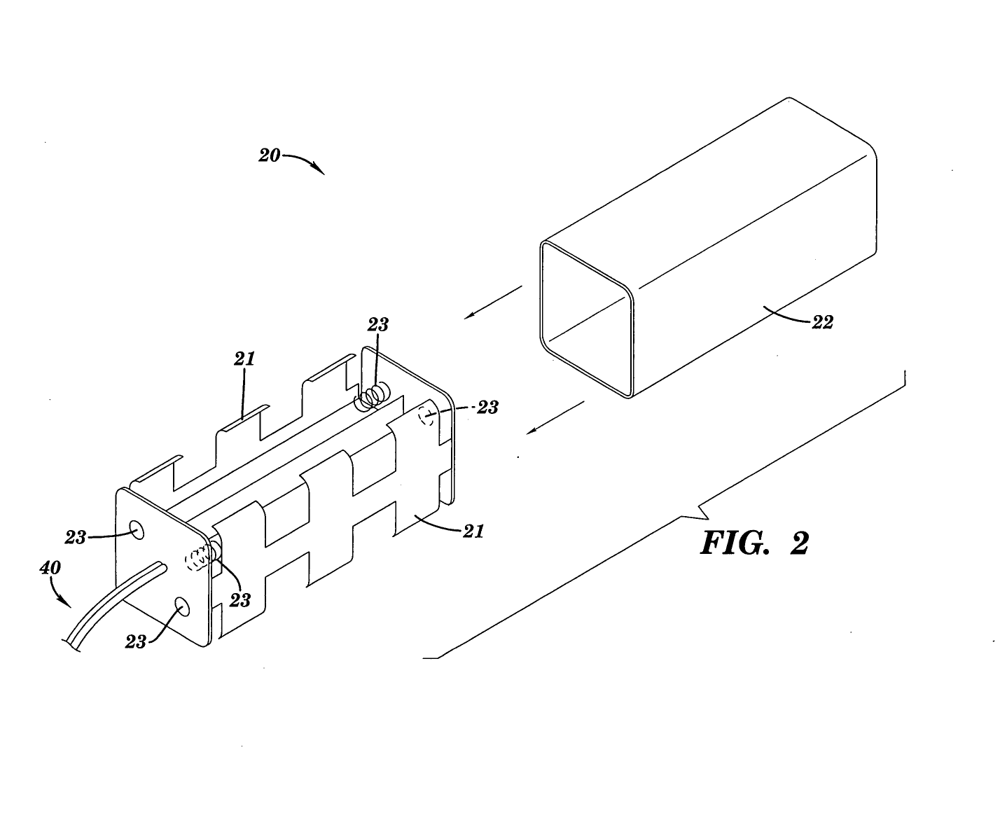

FIG. 2 depicts the power assembly 20, in accordance with the present invention, comprising: a power source case 21, a power source casing 22, and power assembly contacts 23. Referring to FIG. 1 and FIG. 2, the case 21 is designed such that a power source can exist or be placed within the case 21. In an embodiment of the present invention the power source may be but is not limited to disposable alkaline batteries such as AA, AAA, C, D size, and the like or rechargeable batteries such as AA, AAA, C, D size, and the like. Alternatively, other power sources operatively adaptable to the power assembly 20 include vehicle cigarette lighters, portable generators, gel cells, auto jump packs, solar cells, wet cells, and the like.

The power source casing 22 protects the power source within the case 21 from weather elements such as rain, cold, dirt, snow, and the like. The casing 22 is designed to allow the case 21 to easily slide in and out of the casing 22 such that the power source may be easily installed or uninstalled. The casing 22 typically is made of plastic such as low density polyethylene (LDPE), high density polyethylene (HDPE), and the like but may also be made of materials such as steel, aluminum, iron, composite materials, and the like as well as combinations thereof.

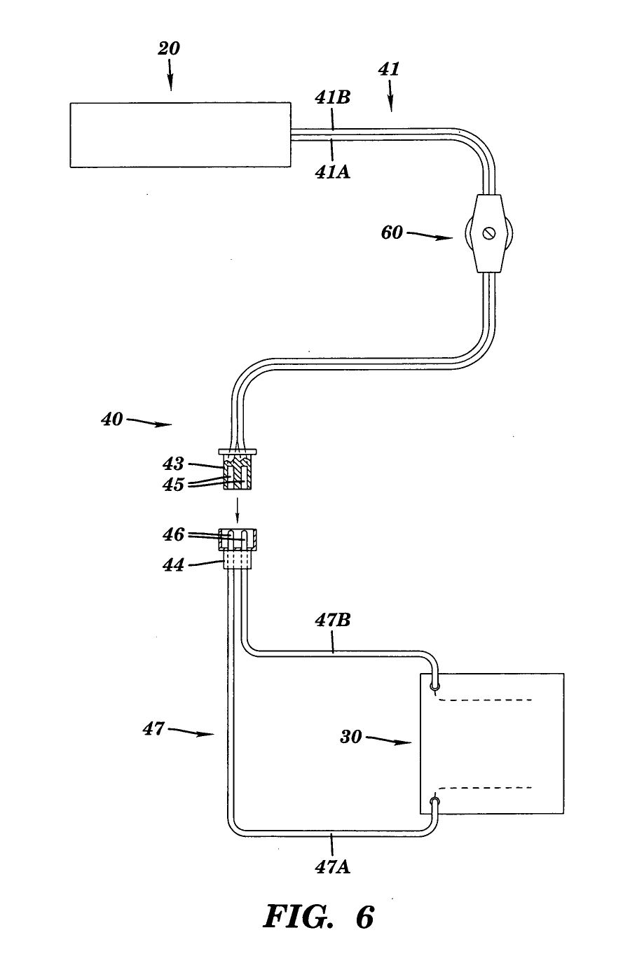

The assembly contacts 23 interconnect the power assembly 20 and the PDN 40. The contacts 23 are in contact with the PDN 40 via a first power distribution network (PDN) conduit 41 (e.g., See FIG. 6) thus allowing for the power generated by the power source to be transferred to the PDN 40. The contacts 23 are typically made of materials that are capable of conducting the power.

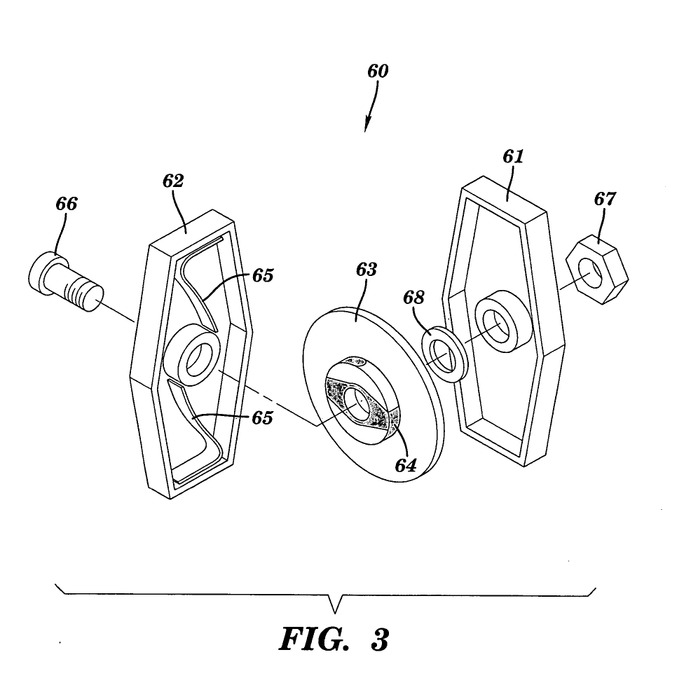

FIG. 3 depicts an exploded view of a power control unit (PCU) 60, in accordance with the present invention, comprising: a top casing 61, a bottom casing 62, a switch 63, a center terminal 64, a lead 65, a screw 66, a nut 67, and a washer 68.

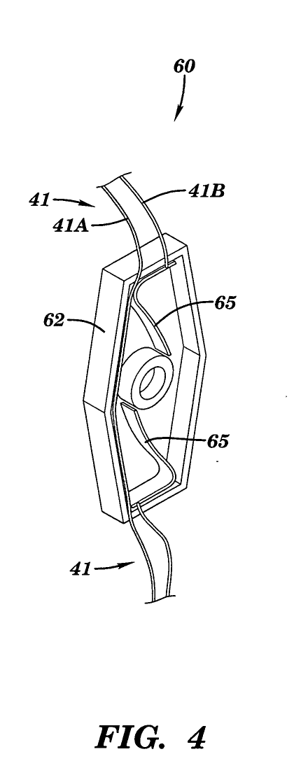

FIG. 4 depicts a cross-sectional view of the bottom half of the PCU 60, in accordance with the present invention, comprising: the bottom casing 62, the lead 65, and the first PDN conduit 41. The conduit 41 further comprises a positive line 41A and a negative line 41B. Referring to FIG. 3 and FIG. 4, the top casing 61 and the bottom casing 62 conform to each other such that the components: the top casing 61, the bottom casing 62, the switch 63, the lead 64, the center terminal 65, the screw 66, the nut 67, and the washer 68 are contained within the casings 61 and 62.

The top casing 61 and the bottom casing 62 is typically made of plastics such as low density polyethylene (LDPE), high density polyethylene (HDPE), and the like. The PCU lead 64 and the center terminal 65 are typically made of materials capable of conducting power generated by the power assembly 20. The lead 64 is in contact with the negative wire 41B of the power conduit 41. Alternatively, the lead 64 may be in contact with a positive wire 41A of the power conduit 41. As shown in FIG. 3, the screw 66 passes through the top casing 61, the washer 68, the PCU switch 63, the central terminal 64, and the bottom casing 62 to the nut 67 thus holding the PCU 60 together.

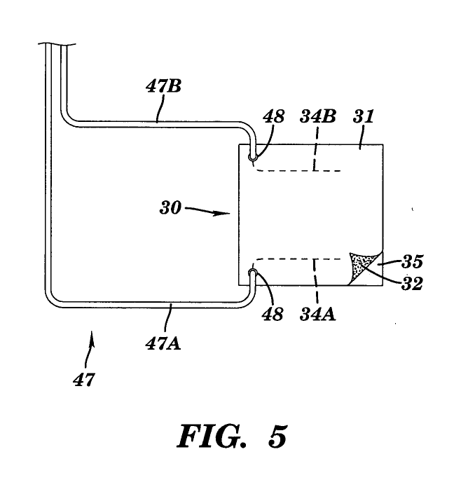

FIG. 5 depicts a perspective view of a heating assembly 30, in accordance with present invention, comprising: a carbon based heating component 31, an assembly securing constituent 32, an assembly securing constituent cover 35, and conducting buses 34A and 34B. The heating component 31 is made from carbon based materials including but not limited to carbon fiber, powered graphite, graphite, woven carbon fiber, laid carbon fiber, carbon nanocomposites and the like or combinations thereof. The heating component 31 is typically configured in a shape that includes but is not limited too a rectangle, a circle, linear strips, a trapezoid, a ellipsoid, and combinations thereof. The heating component 31 is able to receive current generated by the power assembly 20 (e.g., See FIG. 1) via the heating assembly contacts 48.

The contacts 48 are operatively attached to the conducting buses 34A and 34B, and allow the current to pass from the conducting bus 34A to the conducting bus 34B. The elements 34A and 34B are located within the heating component 31, and typically near the outer borders of the heating component 31 as well as parallel to the outer borders. Alternatively though, the conducting buses 34A and 34B may run in any direction within the heating component 31. The conducting buses 34A and 34B are secured within the heating component 31 by sandwiching the carbon based material over the buses 34A and 34B.

The conducting buses 34A and 34B are typically made of copper. Alternatively, the buses 34A and 34B may be made of any material capable of conducting current can be used in an embodiment of the present invention. The heating assembly 30 produces heat in a temperature range from about 1° C. to about 189° C. The securing constituent 32 is an adhesive on one side of the heating component 31 that allows a user to adhere the heating component 31 to an article of wear or directly on a region of the body for heating purposes. Alternatively, the securing element 31 may be a hook or loop that secures the heating component 31 to the article of wear or directly on the region of body for heating purposes.

FIG. 6 depicts a power distribution network (PDN) 40, in accordance with the present invention, comprising: a first power conduit 41, a first power conduit junction 43, a second power conduit junction 44, a first power conduit junction contact 45, a second power conduit junction contact 46, a second power conduit 47, and heating assembly contacts 48. Referring to FIGS. 2, 3, and 6, the power conduit 41 interconnects the power assembly 20 and the PCU 60 via the power assembly contacts 23 and the PCU lead 65. The power conduit 41 further comprises a positive line 41A and a negative line 41B.

The power conduit junction 43 contains within its body the conduit junction contacts 45 to which is connected the positive line 41A and the negative line 41B. The power conduit junction 44 also contains, within its body, the conduit junction contacts 46 to which is connected the positive line 47A and the negative line 47B of the second power conduit 47. The power conduit 47 is attached to the heating assembly 30 via the heating assembly contacts 48. The power conduit junctions 43 and 44 are conformed such that the conduit junctions 43 and 44 snap-fit together to form a non-integral connection. The resultant connection allows power generated to flow through the PDN 40 to the heating assembly 30.

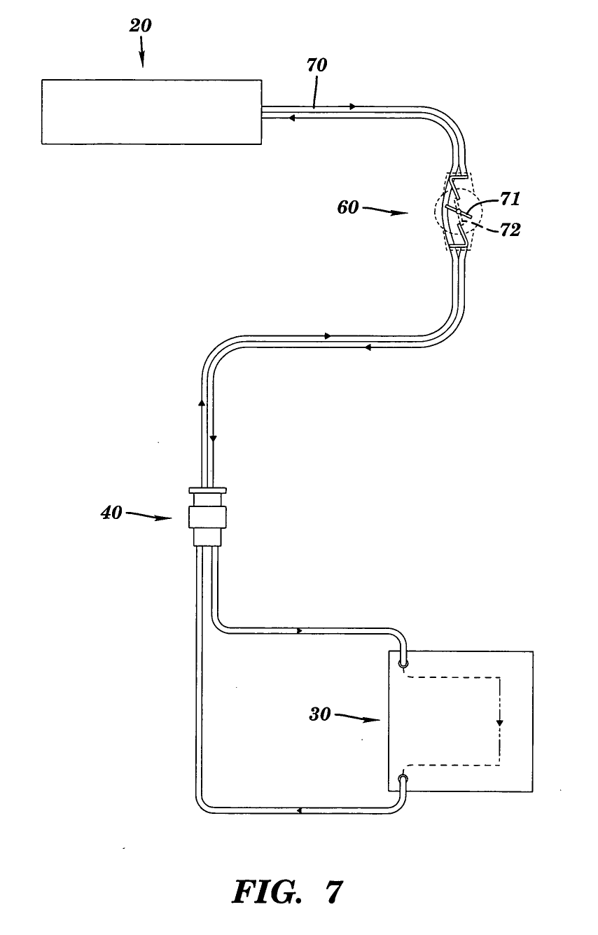

FIG. 7 depicts a schematic of a power flow of the heating device 10. In accordance with the present invention, an embodiment further includes operation of the device 10 typically having two operational positions of the PCU 60: an open circuit position 71 (OPEN) and a closed circuit position 72 (CLOSED). A power 70 is generated by the power assembly 20 and travels to the heating assembly 30 via the PDN 40. The PCU 60 controls the flow of power 70 along the PDN 40 by being in one of two positions; OPEN 71 or CLOSED 72.

OPEN 71 does not allow the power 70 to flow from the PCU 60 along the PDN 40 to the heating assembly 30. As shown in FIG. 7, the PCU center terminal 64 is not in connection with the PCU leads 65, thus the power 70 that flows along the power conduit 41 between the power assembly 20 and the PCU 60 is unable to flow through the PCU 60 to the rest of the PDN 40. Without the power 70, the heating assembly 30 can not generate heat and there is unable to heat a region the body.

CLOSED 72 allows power 70 to flow from the PCU 60 along the PDN 40 to the heating assembly 30. As shown in FIG. 7, the PCU center terminal 64 is in connection with the PCU leads 65, thus the power 70 that flows along the power conduit 41 between the power assembly 20 and the PCU 60 is able to flow through the PCU 60 to the rest of the PDN 40. With the power 70, the heating assembly 30 can generate heat and therein is able to heat a region the body.

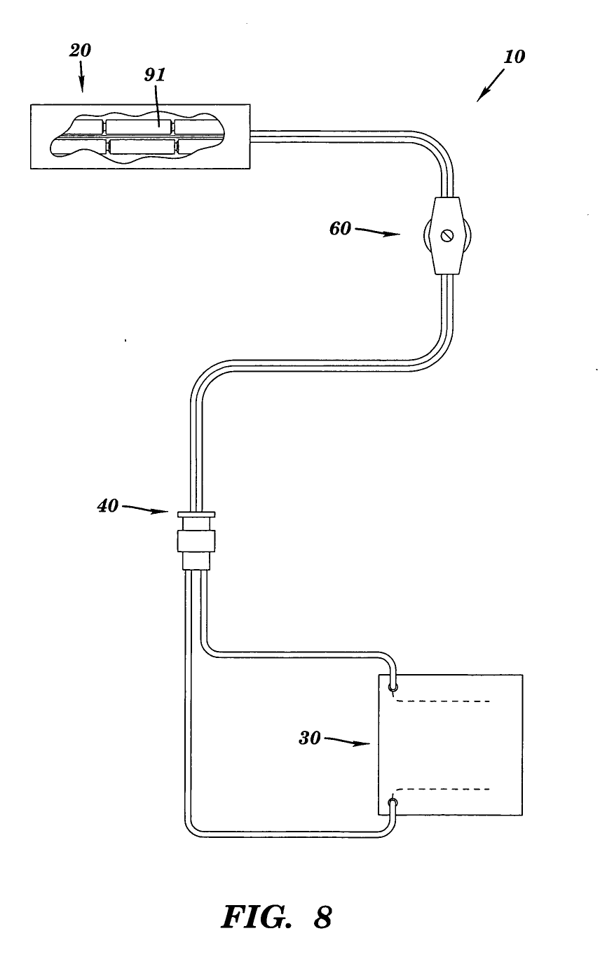

FIG. 8 depicts the heating device 10 of FIG. 1 having a power source 91. An embodiment of the present invention is a heating device 10 for heating a region of the human body, specifically the epidermis. To prepare the heating device 10 for heating purposes, a user must first install a power source 91 into the power assembly 20 of the heating device 10. The power source may be a disposable alkaline battery such as an AA, AAA, C, D, and the like or reusable batteries such as AA, AAA, C, D, and the like, but not limited to the aforementioned.

Alternatively, the power source may be any battery or device capable of producing power and capable of being operatively coupled to the device 10 such that the device 10 is able to use the power produced to generate heat via the heating assembly 30. Examples of alternate power sources include but are not limited to a car battery, a snowmobile battery, an all-terrain vehicle battery, a gas operated generator, a wet cell, a gel cell, a solar cell, and the like.

Referring to FIG. 1-FIG. 8, in operation of the device, typically 8 AA batteries are used as the power source 91. The power source container casing 22 is removed from the power source case 21 by pulling and sliding the container casing 22 away from the case 21. The batteries may be installed by snapping the batteries into place within the case 21 and subsequently sliding the container casing 22 back onto the case 21. The arrangement of the batteries within the container 21 is typically well known to one ordinarily skilled in the art.

Upon installation of the batteries, power 70 is available for the heating device 10 to generate heat. The power 70 is a current typically an electrical current of 0.04 Amps, 12 Volts, 9 Watts, and 12 Ohms. From hereon, the power 70 generated will be referred to as a current 92. The range of the current 92 capable of powering the heating device 10 is in a range from about 0.04 Amps to about 0.08 Amps, any DC current available, in a range from about 7 Watts to about 14 Watts, and in a range from about 8 Ohms to about 20 Ohms. The current 92 travels from the power assembly 20 through the power assembly contacts 23 to the negative line 41B of the first power conduit 41 of the power distribution network (PDN) 40. The current 92 continues along the line 41B to the power control unit (PCU) 60.

The PCU 60 controls the flow of current 92 along the PDN 40. The PCU 60 is typically OPEN 71 thus not allowing the current 92 to flow from the PCU 60 along the PDN 40 to the heating assembly 30. Flipping the PCU switch 63 to CLOSED 72 position allows the current 92 to travel through the PCU 60 and further along the negative line 41B of the first power conduit 41 to the first junction conduit 43 and the second junction conduit 44. From the junction conduit 44, the current 92 flows along the negative line 47B of the second power conduit 47 to the heating assembly contacts 48.

The current 92 flow continues to the conducting bus 34B, through the carbon based heating component 31 to the conducting bus 34A. The heating component 31 has a resistance to the current 92 flow from the conducting bus 34B to the conducting bus 34A. The resistance of the heating component 31 is physically manifested as heat. The greater the time the current 92 spends flowing through the heating component 31, the greater the resistance becomes and subsequently the greater the amount of heat is generated by the heating component 31. The current 92 then flows back to the power source 80 via the positive line 47B of the second power conduit 47, through the PDN 40 to the PCU 60, back to the power assembly 20 via the positive line 41A of the first power conduit 41.

The amount of the heat generated, i.e., the temperature of the heating component 31 can be controlled and varied by the amount of time the PCU 60 is CLOSED 72. One embodiment for controlling the temperature of the heating component 31 is having the PCU 60 in a CLOSED 72 position for a pre-determined period of time. For example, having the PCU 60 CLOSED 72 for about 10 sec to about 15 sec will result in the carbon fiber element 31 having a surface temperature of about 50° C. to about 70° C. Having the PCU 60 CLOSED 72 for about 35 sec to about 40 sec will result in the heating component 31 having a temperature of about 130° C. to about 170° C. Table 1 below lists different time settings with the PCU 60 CLOSED 72 and the resultant temperatures.

TABLE 1

| Time | Temperature ° C. |
|---|---|
| 10 s-15 s | 50° C.-70° C. |
| 20 s-30 s | 70° C.-100° C. |
| 30 s-35 s | 100° C.-130° C. |
| 35 s-40 s | 130° C.-170° C. |
| 40 s-50 s | 170° C.-189° C. |

Another embodiment for controlling and varying the temperature of the heating component 31 is to switch the PCU 60 back and forth between the CLOSED 72 position and the OPEN 71 position. The switching positions results in resistance steadily building up within the heating component 31 and subsequently generating heat. For example, having the PCU 60 CLOSED 72 for about 10 sec to about 30 sec; then switching the PCU 60 OPEN 72 for about 10 sec to about 30 sec; and then switching the PCU 60 back to CLOSED 72 for about 10 sec to about 30 sec will result in the heating component 31 having a temperature of about 40° C. to about 50° C. Switching between the CLOSED 72 and the OPEN 71 position can be repeated any number of times with any time interval to allow the carbon fiber element 31 to generate a comfortable amount of heat for heating an epidermal region of the body.

FIG. 8 depicts a heating system 90 for heating epidermal regions of a human body, in accordance with the present invention. An embodiment of the present invention is the heating system 90 comprising: a power source 91, a power assembly 20, a power control unit (PCU) 60, a heating assembly 30, and a power distribution network (PDN) 40.

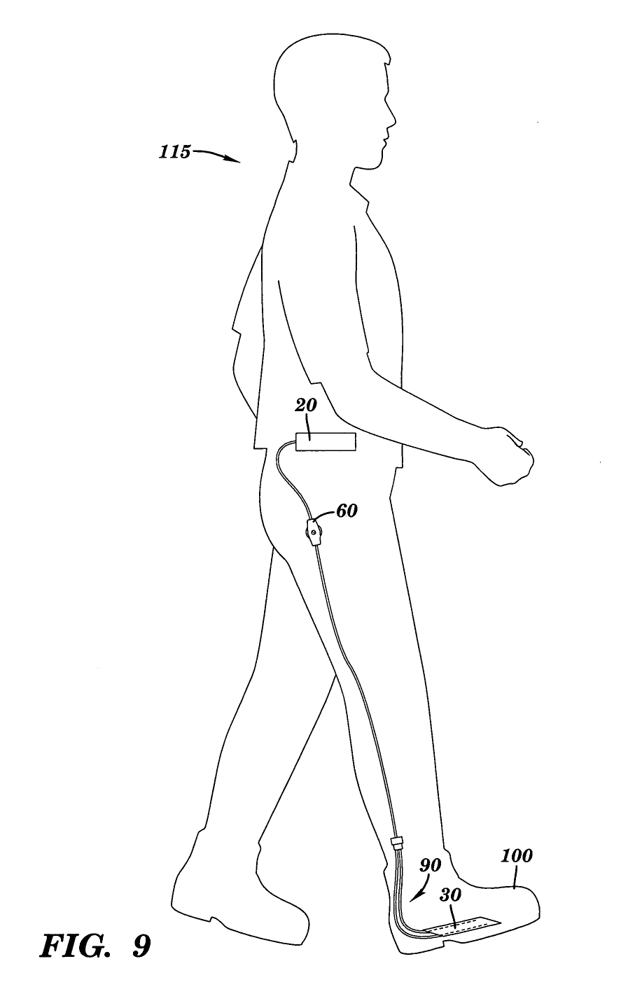

FIG. 9 depicts a view of a user 115 having the heating system 90 on their person. An embodiment of the heating system 90 is heating of a podalic region. The power assembly 20 is operatively secured to the user 115 with the power control unit 60 within range for ease of use. The heating assembly 30 is placed within the boot 100 for localized heating of the podalic region.

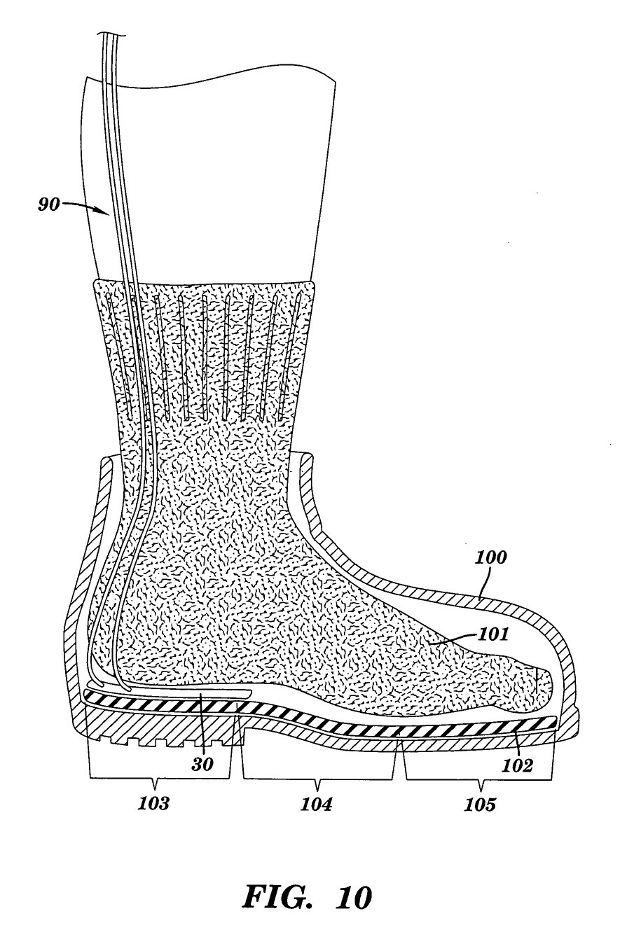

FIG. 10 depicts a cross section of the boot 100 having the heating system 90. An embodiment of the heating system 90 is heating of a podalic region, while in a boot, in accordance with the present invention. Referring to FIG. 1-FIG. 10 in operation of the heating system 90, the heating system 90 is prepared for use by installing the power source 91 into the power assembly 20. In this example, the power source 91 is 8 AA batteries. The user 115 then places the heating assembly 30 onto an insole 102 of the boot 100.

The user can place the heating assembly 30 on any region of the insole 102. For the purpose of example, the insole 102 has been divided into three regions: a back 103, a middle 104, and a front 105. In an embodiment, the heating assembly 30 is placed on the back 103 region of the insole 102. The heating assembly 30 may be secured to the back 103 region by removing the assembly securing constituent cover 35 and exposing the assembly securing constituent 32. The securing constituent 32 is an adhesive that cab stick to an object when placed onto that object. Pressing the assembly securing constituent 32 to the back 103 region of the insole 102 secures the heating assembly 30 to the insole 102.

After the heating assembly 30 has been secured, the power assembly 20 may be operatively clipped via the power assembly clip 24 to an article of wear on the user. Typically to a belt or a waistband of the user's trousers. This allows the PDN 40 to freely hang along the side of the user for easy access to the PCU 60 while allowing the second power conduit 47 of the PDN 40 to operatively extend into the boot 100 to the heating assembly 30 without any discomfort to the user 115. Alternatively, the entire PDN 40 may extend from the boot 100, underneath the user's 115 clothing, and up to the belt or the waistband of the user's 115 trousers. This allows for concealment of the heating system 90 while still maintaining ease of operation.

The installation and uninstallation of the heating system 90 within the boot 100 is non-destructive to the boot 100 and does not require any modification to the boot 100. A user 115 may uninstall the heating system 90 simply by peeling the heating assembly 30 of off the insole 102 and withdrawing the heating assembly 30 and the PDN 40 from the boot 100. Alternatively, if the user 115 wishes to heat a different region of the boot 100, for example the front region 105, the user needs only to peel the heating assembly 30 from the back region 103 and affix the heating assembly 30 to the front region 105.

After installing the heating system 90 in the boot 100, the heating system 90 is ready to generate heat by operation of the PCU 60. As previously described earlier, the user 115 may throw the PCU switch 63 to the CLOSED 72 position for a period of time (See Table 1), chosen by the user 115, to generate an amount of heat that comfortably warms the foot 101 of the user 115 and then throw the switch 63 back to the OPEN 71 position to stop further heat generation. Once a particular level of heat/comfort level has been achieved, it may be maintained by switching between the two positions CLOSED 72 and OPEN 71 intermittently over a period of about 1 to about 4 hours or for a time as long as necessary that is deemed by the user 115.

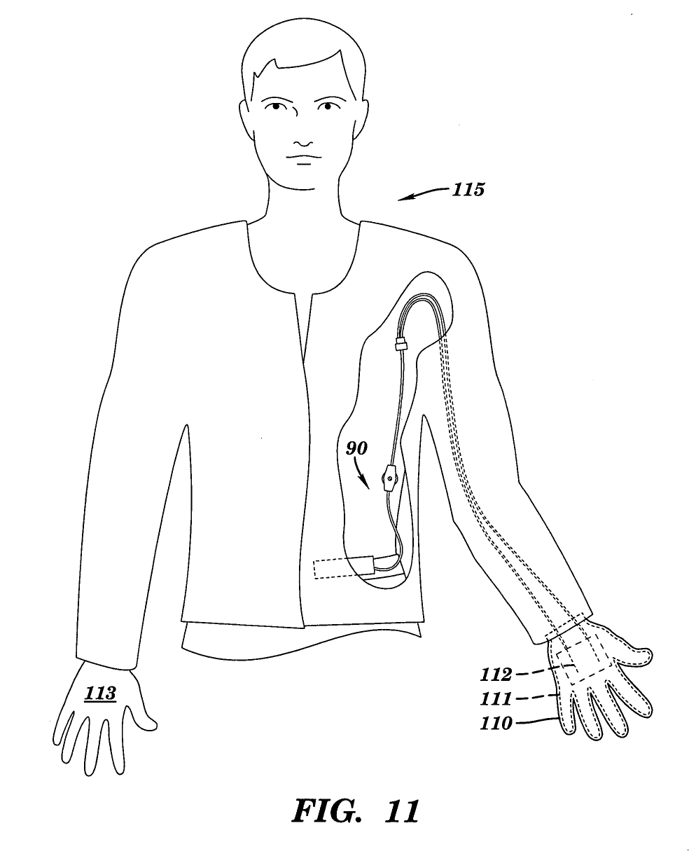

FIG. 11 depicts a view of a glove 110 having the heating system 90. An embodiment of the heating system 90 is heating of the epidermis of a hand 111 while in the glove 110, in accordance with the present invention. Referring to FIG. 1-FIG. 8 and FIG. 11 in operation of the heating system 90, the heating system 90 is prepared for use by installing the power source 91 into the power assembly 20. In this example, the power source 91 is 8 AA batteries. The user 115 then places the heating assembly 30 onto the inside of the glove 110.

The user 115 can place the heating assembly 30 on any region inside the glove 110. For the purpose of example, the glove 110 has been divided into two regions: a palm side 112 and a backhand side 113. In an embodiment, the heating assembly 30 is placed on the backhand side 113 of the glove 110. The heating assembly 30 may be secured to the backhand 113 by removing the assembly securing constituent cover 35 and exposing the assembly securing constituent 32. Pressing the assembly securing constituent 32 to the backhand 113 secures the heating assembly 30 to the backhand 113 of the glove 110.

After the heating assembly 30 has been secured, the power assembly 20 may be operatively clipped via the power assembly clip 24 to an article of wear on the user 115, typically to a belt or a waistband of the user's 115 trousers. Alternatively, the power assembly 20 may placed in a shirt pocket, an inside pocket of an outer garment, or an outside pocket of an outer garment.

The entire PDN 40 may extend from heating assembly 30 in the glove 110, underneath the user's 115 clothing, such as an outer garment sleeve or shirt sleeve, and to the power assembly 20 clipped to user's 115 belt or trouser waistband. Alternatively, if the power assembly 20 is placed in a pocket, the entire PDN 40 may extend from heating assembly 30 in the glove 110, underneath the user's clothing, such as an outer garment sleeve or shirt sleeve, and to the power assembly 20 located in the pocket. Both examples allow for concealment of the heating system 90 while still maintaining ease of operation.

The installation and uninstallation of the heating system 90 within the glove 110 is non-destructive to the glove 110 and does not require any modification to the glove 110. A user 115 may uninstall the heating system 90 simply by peeling the heating assembly 30 of off the backhand side 113 of the glove 110 and withdrawing the heating assembly 30 and the PDN 40 from the glove 110. Alternatively, if the user 115 wishes to heat a different region of the glove 110, for example the palm side 112, the user 115 needs only to peel the heating assembly 30 from the backhand 113 and affix the heating assembly 30 to the palm side 112.

After installing the heating system 90 in the boot 100, the heating system 90 is ready to generate heat by operation of the PCU 60. As previously described earlier, the user 115 may throw the PCU switch 63 to the CLOSED 72 position for a period of time (See Table 1), chosen by the user 115, to generate an amount of heat that comfortably warms the foot 101 of the user 115 and then throw the switch 63 back to the OPEN 71 position to stop further heat generation. Once a particular level of heat/comfort level has been achieved, it may be maintained by switching between the two positions CLOSED 72 and OPEN 71 intermittently over a period of about 1 to about 4 hours or for a time as long as necessary that is deemed by the user.

Using the heating system 90, as previously described, to locally heat the podalic and hand regions of the body covered in article of wear is not meant to limit the scope of the heating system 90 in embodiments of the present invention. Any epidermal region of the body covered by an article of wear, especially one designed to protect the epidermal region covered, can utilize the present invention. Other embodiments include but are not limited to heating any epidermal region such as the trunk of the body, the legs, the arms, the feet, the hands, the buttocks, and the like.

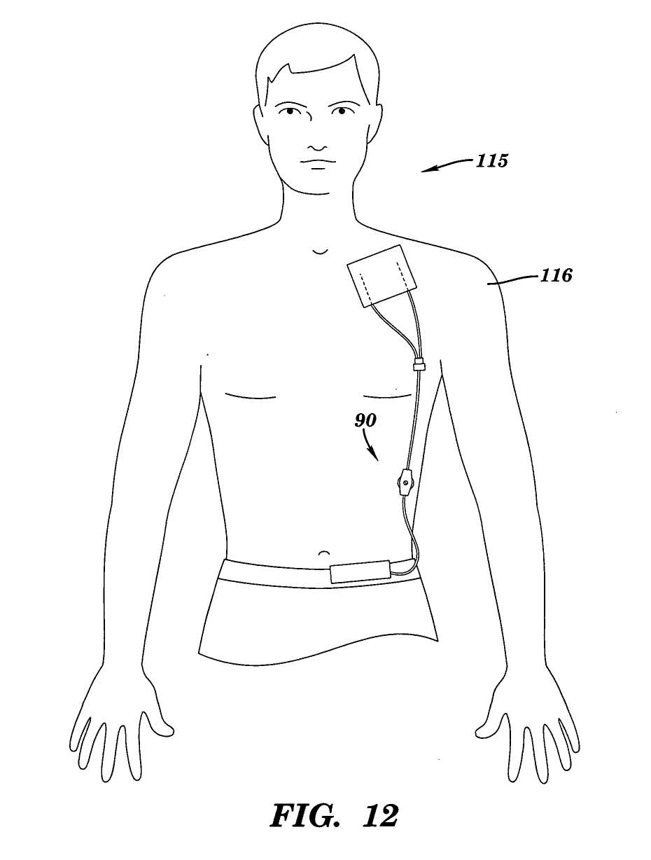

FIG. 12 depicts the heating system 90 in use to heat an upper torso 116 of the body. An embodiment of the heating system 90 is heating of the upper torso 116, uncovered by an article of wear, in accordance with the present invention. Referring to FIG. 1-FIG. 8 and FIG. 12 in operation of the heating system 90, the heating system 90 is prepared for use by installing the power source 91 into the power assembly 20. The user 115 then places the heating assembly 30 onto the upper torso 116 of the body.

The user 115 can place the heating assembly 30 on any epidermal region of the body. In an embodiment, the heating assembly 30 is placed on the upper torso 116 for purposes of heating the upper torso 116. The heating assembly 30 may be secured to the torso 116 by removing the assembly securing constituent cover 35 and exposing the assembly securing constituent 32. The securing constituent 32 is an adhesive that can stick to an object when placed onto the object. Pressing the assembly securing constituent 32 to the torso 116 of the body secures the heating assembly 30 to the torso 116.

After the heating assembly 30 has been secured, the power assembly 20 may be operatively clipped via the power assembly clip 24 to an article of wear on the user 115. Typically to a belt or a waistband of the user's 115 trousers. This allows the PDN 40 to freely hang along the side of the user 115 for easy access to the PCU 60. Alternatively, the heating assembly 30 may be laid to rest nest to the user 115.

The placing and removing of the heating system 90 onto the upper torso 116 is non-painful to the upper torso 116. A user 115 may place the heating system 90 simply by peeling the heating assembly 30 off of the upper torso 116. Alternatively, if the user 115 wishes to heat a different region of the body, for example the upper leg, the user 115 needs only to peel the heating assembly 30 from the upper torso 116 and affix the heating assembly 30 to the upper leg 117.

After placing the heating system 90 on the upper torso 116, the heating system 90 is ready to generate heat by operation of the PCU 60. As previously described earlier, the user 115 may throw the PCU switch 63 to the CLOSED 72 position for a period of time (See Table 1), chosen by the user 115, to generate an amount of heat that comfortably warms the upper torso 116 of the user 115 and then throw the switch 63 back to the OPEN 71 position to stop further heat generation. Once a particular level of heat/comfort level has been achieved, it may be maintained by switching between the two positions CLOSED 72 and OPEN 71 intermittently over a period of about 1 to about 4 hours or for a time as long as necessary that is deemed by the user 115.

Using the heating system 90, as previously described, to locally heat the upper torso 116 of the body not covered in article of wear is not meant to limit the scope of the heating system 90 in embodiments of the present invention. Any epidermal region of the body uncovered by an article of wear can utilize the present invention. Other embodiments include but are not limited to heating any epidermal region such as the trunk of the body, the legs, the arms, the feet, the hands, the buttocks, and the like.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included withing the scope of this invention as defined by the accompanying claims.

1. A heating device for an epidermal region of the body comprising:
a power assembly, wherein the power assembly is for containing a power source;
a heating assembly, wherein the heating assembly includes at least one carbon based heating component;
a power distribution network for distributing power from the power assembly to heating assembly; and
a power control unit, wherein the power control unit manages the power distributed along the distribution network.

2. The device of claim 1, wherein the power source is batteries.

3. The device of claim 2, wherein the batteries are disposable batteries.

4. The device of claim 2, wherein the batteries are re-chargeable.

5. The device of claim 2, wherein the batteries are wet cell, gel cell, and solar panel.

6. The device of claim 1, wherein the power assembly is made of low density polyethylene (LDPE), high density polyethylene (HDPE), steel, aluminum, iron, composite materials, and combinations thereof.

7. The device of claim 1, wherein the heating assembly further comprises: a carbon based heating component, an assembly securing constituent, conducting buses, an assembly securing constituent cover.

8. The device of claim 1, wherein the carbon based heating component is in the shape of a rectangle, circle, trapezoid, ellipsoid, or combinations thereof.

9. The device of claim 7, wherein the carbon based heating component is made of carbon fiber, powered graphite, graphite, woven carbon fiber, laid carbon fiber, and carbon nanocomposites or combinations thereof.

10. The device of claim 7, wherein the assembly securing constituent is an adhesive.

11. The device of claim 7, wherein the conducting buses are made of materials capable of conducting current.

12. The device of claim 7, wherein the conducting buses are made of copper.

13. The device of claim 1, wherein the power source is a snowmobile battery.

14. The device of claim 1, wherein the carbon based heating component can generate heat in a temperature range from about 1° C. to about 189° C. in a time range from about 35 sec to about 50 sec.

15. A method for heating an epidermal region of the body comprising:
providing a power assembly, wherein the power assembly is for containing a power source;
providing a heating assembly, wherein the heating assembly includes at least carbon based heating component;
providing a power distribution network for distributing power from the power assembly to the heating assembly;
providing a power control unit, wherein the power control unit manages the power distributed along the distribution network; and
applying heat.

16. The method of claim 15, wherein the power source is at least one battery.

17. The method of claim 16, wherein at least one battery is a disposable battery.

18. The method of claim 16, wherein at least one battery is a re-chargeable battery.

19. The method of claim 18, wherein at least one re-chargeable battery is a wet cell battery, a gel cell battery, or a solar panel.

20. The method of claim 15, wherein the power assembly is made of low density polyethylene (LDPE), high density polyethylene (HDPE), steel, aluminum, iron, composite materials, and combinations thereof.

21. The method of claim 15, wherein the heating assembly further comprises: an assembly securing constituent, conducting buses, and an assembly securing constituent cover.

22. The method of claim 15, wherein the carbon based heating component is in the shape of a rectangle, circle, trapezoid, ellipsoid, and combinations thereof.

23. The method of claim 15, wherein the carbon based heating component is made of carbon fiber, powered graphite, graphite, woven carbon fiber, laid carbon fiber, and carbon nanocomposites or combinations thereof.

24. The method of claim 21, wherein the assembly securing constituent is an adhesive.

25. The method of claim 21, wherein the carbon based heating component can generate heat in a temperature range from about 1° C. to about 189° C. in a time from about 5 sec to about 50 sec.

26. The method of claim 15, wherein the power source is a snowmobile battery.

27. A system for heating comprising:
a power source, wherein the power source is capable of producing power;
a power assembly, wherein the power assembly is for containing the power source;
a heating assembly, wherein the heating assembly includes at least one carbon based heating component;
a power distribution network for distributing power from the power assembly to the heating assembly; and
a power control unit, wherein the power control unit manages the power distributed along the power distribution network.

28. The system of claim 27, wherein the power source is at least one battery.

29. The system of claim 27, wherein the battery may be disposable battery.

30. The system of claim 27, wherein the battery may be re-chargeable battery.

31. The system of claim 30, wherein the re-chargeable battery is a wet cell battery, a gel cell battery, or a solar panel.

32. The system of claim 27, wherein the power assembly is made of low density polyethylene (LDPE), high density polyethylene (HDPE), steel, aluminum, iron, composite materials, and combinations thereof.

33. The system of claim 27, wherein the heating assembly comprises: a carbon based heating component, an assembly securing constituent, conducting buses, and an assembly securing constituent cover.

34. The system of claim 27, wherein the carbon based heating component is in the shape of a rectangle, circle, trapezoid, ellipsoid, and combinations thereof.

35. The system of claim 27, wherein the carbon based heating component is made of carbon fiber, powered graphite, graphite, woven carbon fiber, laid carbon fiber, and carbon nanocomposites or combinations thereof

36. The system of claim 33, wherein the assembly securing constituent is an adhesive.

37. The system of claim 33, wherein the conducting buses are made of materials capable of conducting current.

38. The system of claim 33, wherein the conduct buses are made of copper.

39. The system of claim 27, wherein the carbon based heating device can generate heat in a temperature range from about 1° C. to about 189° C. in time range from about 5 sec to about 50 sec.

40. The system of claim 33, wherein the power source is a snowmobile battery.
